(19) United States
(12) Patent Application Publication
(10) Pub. No.: US 2026/0273746 A1
(43) Pub. Date: Sep. 17, 2026

(54) IOT SYSTEMS, METHODS, AND MEDIA FOR SENSOR-BASED HUMAN-ROBOT COLLABORATIVE MONITORING

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Bin LIU, Chengdu (CN); Yaqiang QUAN, Chengdu (CN); Chang SU, Chengdu (CN)

(73) Assignee: CHENGDU QINCHUAN IOT TECHNOLOGY CO., LTD., Chengdu (CN)

(21) Appl. No.: 19/674,119

(22) Filed: May 11, 2026

(30) Foreign Application Priority Data
Apr. 2, 2026 (CN) 202610425293.0

(51) Int. Cl. B25J 9/16; G16Y 40/10; G16Y 40/50

(52) U.S. Cl. CPC B25J 9/1666; B25J 9/161; B25J 9/163; B25J 9/1676; G16Y 40/10; G16Y 40/50

(57) ABSTRACT

An IoT system, method, and medium for sensor-based human-robot collaborative monitoring are provided. The method includes: obtaining monitoring data of a work area of a collaborative robot; determining a collision risk value based on the monitoring data, a first motion trajectory of an operator, and a second motion trajectory of the collaborative robot; determine an avoidance parameter of the collaborative robot based on the monitoring data, the first motion trajectory, the collision risk value, a collision urgency degree, and a movable space range of the collaborative robot; and generating a motion control instruction based on the avoidance parameter and send the motion control instruction to a motion control system of the collaborative robot, wherein the motion control system is configured to adjust a physical drive signal applied to a joint motor based on the motion control instruction, to drive mechanical links of the collaborative robot to produce a composite motion.

### CROSS-REFERENCE TO RELATED APPLICATIONS

This application claims priority of Chinese Patent Application No. 202610425293.0 filed on Apr. 2, 2026, the contents of which are hereby incorporated by reference in its entirety.

### TECHNICAL FIELD

The present disclosure relates to the field of human-robot collaborative safety technology, and in particular, to an Internet of Things (IoT) system, a method, and a medium for sensor-based human-robot collaborative monitoring.

### BACKGROUND

Currently, collaborative robots have been widely introduced in various industrial fields. The collaborative robots share the same physical space with operators. To ensure the safety and operational efficiency of human-robot collaboration, the monitoring of the human-robot collaboration is particularly important.

Currently, human-robot collaborative monitoring systems generally have problems such as a single perception means and poor robustness. In complex industrial environments such as lighting changes and metal reflections, the human-robot collaborative monitoring systems are prone to false alarms or missed detections. Furthermore, the human-robot collaborative monitoring systems cannot perceive and adapt to different task scenarios. Consequently, safety responses are delayed, and human-robot interactions are rigid. It is difficult to achieve a balance between ensuring absolute safety and achieving efficient and smooth collaborative operations.

Therefore, it is an urgent need to provide an Internet of Things (IoT) system, a method, and a medium for sensor-based human-robot collaborative monitoring to solve the problems of inaccurate perception, the lack of predictive capability, and the inability to adapt to dynamic tasks in human-robot collaborative monitoring systems. The IoT system, the method, and the medium achieve full automation from perception, decision-making, to execution, thereby significantly improving the safety and operational efficiency of human-robot collaboration.

### SUMMARY

One or more embodiments of the present disclosure provide an IoT system for sensor-based human-robot collaborative monitoring, comprising a collaborative supervision and management platform. The collaborative supervision and management platform is configured to: obtain monitoring data of a work area of a collaborative robot; determine a collision risk value based on the monitoring data, a first motion trajectory of an operator, and a second motion trajectory of the collaborative robot; determine an avoidance parameter of the collaborative robot based on the monitoring data, the first motion trajectory, the collision risk value, a collision urgency degree, and a movable space range of the collaborative robot; and generate a motion control instruction based on the avoidance parameter and send the motion control instruction to a motion control system of the collaborative robot, wherein the motion control system is configured to adjust a physical drive signal applied to a joint motor based on the motion control instruction, to drive mechanical links of the collaborative robot to produce a composite motion, enabling an end effector to complete avoidance.

One or more embodiments of the present disclosure provide a method for sensor-based human-robot collaborative monitoring, wherein the method is executed by a collaborative supervision and management platform in an IoT system for sensor-based human-robot collaborative monitoring. The method comprises: obtaining monitoring data of a work area of a collaborative robot; determining a collision risk value based on the monitoring data, a first motion trajectory of an operator, and a second motion trajectory of the collaborative robot; determining an avoidance parameter of the collaborative robot based on the monitoring data, the first motion trajectory, the collision risk value, a collision urgency degree, and a movable space range of the collaborative robot; and generating a motion control instruction based on the avoidance parameter and sending the motion control instruction to a motion control system of the collaborative robot. The motion control system is configured to adjust a physical drive signal applied to a joint motor based on the motion control instruction, to drive mechanical links of the collaborative robot to produce a composite motion, enabling an end effector to complete avoidance.

One or more embodiments of the present disclosure provide a non-transitory computer-readable storage medium, storing computer instructions, wherein when a computer reads the computer instructions in the storage medium, the computer executes the method for sensor-based human-robot collaborative monitoring.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating an exemplary platform structure of an IoT system for sensor-based human-robot collaborative monitoring according to some embodiments of the present disclosure;

FIG. 2 is a flowchart illustrating an exemplary process for sensor-based human-robot collaborative monitoring according to some embodiments of the present disclosure;

FIG. 3 is an exemplary schematic diagram of determining a collision risk value according to some embodiments of the present disclosure; and

FIG. 4 is an exemplary schematic diagram of a sequence prediction model according to some embodiments of the present disclosure.

### DETAILED DESCRIPTION

The drawings required for describing the embodiments are briefly introduced below. The drawings do not represent all embodiments.

The terms “system,” “device,” “unit,” and/or “module” used in the present disclosure are a manner for distinguishing components, elements, parts, sections, or assemblies of different levels. If other words may achieve the same purpose, the words may be replaced by other expressions.

As shown in the present disclosure, unless the context clearly indicates an exception, the terms “a,” “an,” “one,” and/or “the” are not specifically singular and may also include plural. Generally, the terms “include” and “contain” only indicate inclusion of explicitly identified steps and elements, and these steps and elements do not constitute an exclusive list; a method or a device may also include other steps or elements.

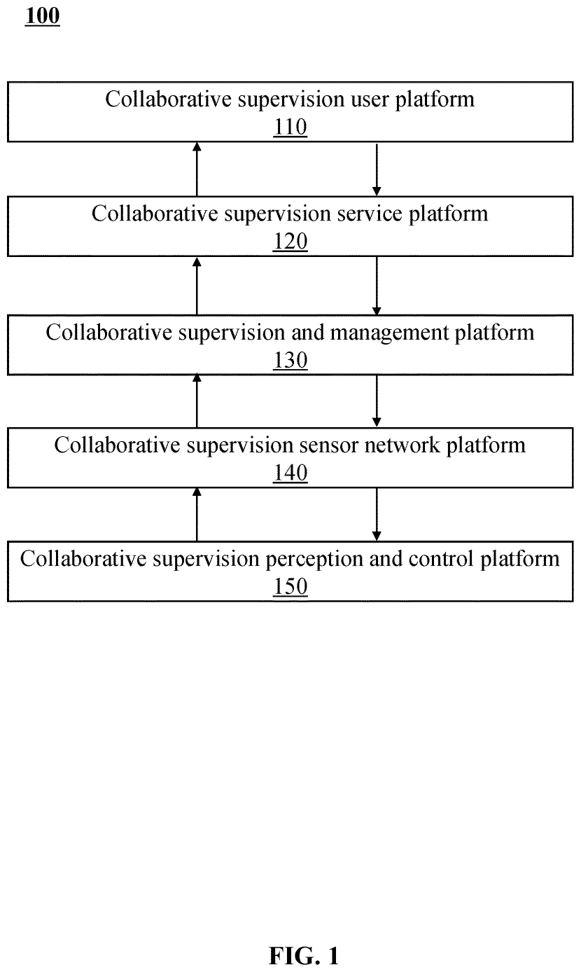

FIG. 1 is a schematic diagram illustrating an exemplary platform structure of an IoT system for sensor-based human-robot collaborative monitoring according to some embodiments of the present disclosure.

In some embodiments, as shown in FIG. 1, an IoT system for sensor-based human-robot collaborative monitoring 100 includes a collaborative supervision user platform 110, a collaborative supervision service platform 120, a collaborative supervision and management platform 130, a collaborative supervision sensor network platform 140, and a collaborative supervision perception and control platform 150.

The collaborative supervision user platform 110 refers to a platform that initiates collaborative supervision requirements and receives collaborative supervision feedback information. The collaborative supervision user platform 110 may be configured as a user terminal, for example, a computer or other device having an input and/or output function.

The collaborative supervision service platform 120 refers to an interactive service platform that receives and transmits collaborative supervision data. The collaborative supervision service platform 120 includes a server, a gateway, a router, or the like.

In some embodiments, the collaborative supervision service platform interacts upward with the collaborative supervision user platform and interacts downward with the collaborative supervision and management platform.

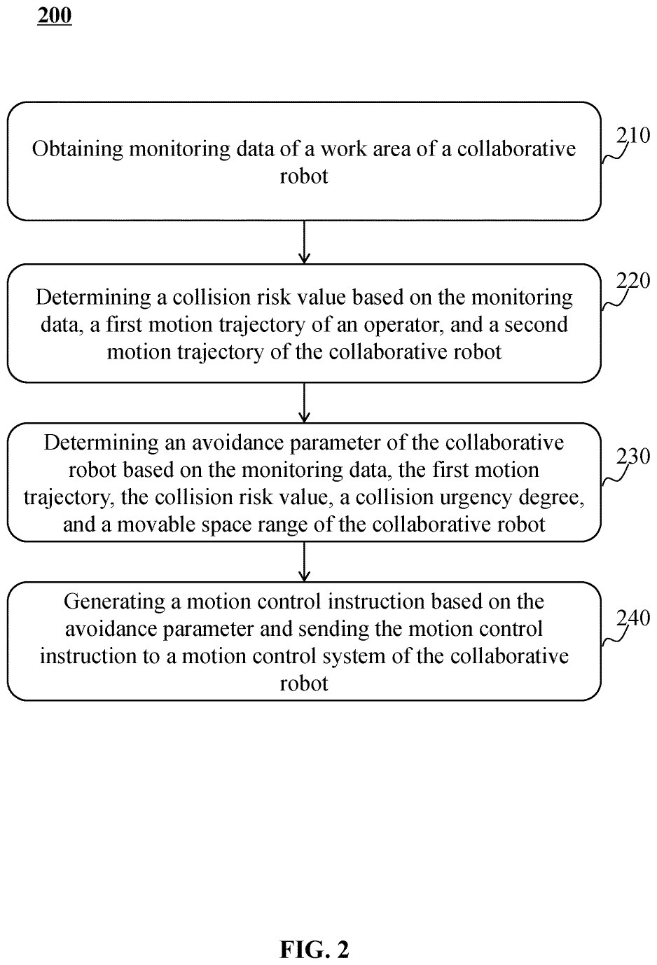

The collaborative supervision and management platform 130 refers to a comprehensive platform that processes and manages the collaborative supervision data. In some embodiments, the collaborative supervision and management platform is configured to execute a method for sensor-based human-robot collaborative monitoring. More descriptions regarding the method may be found in the related descriptions of FIG. 2 to FIG. 4.

In some embodiments, the collaborative supervision and management platform may include a processor and/or a server, a data center, or the like. The data center is configured with a storage device.

The collaborative supervision sensor network platform 140 refers to a platform that transmits collaborative supervision-related sensor data or information. The collaborative supervision sensor network platform 140 includes a communication transmission network and a routing device.

In some embodiments, the collaborative supervision sensor network platform interacts upward with the collaborative supervision and management platform and interacts downward with the collaborative supervision perception and control platform.

The collaborative supervision perception and control platform 150 refers to a platform for acquiring collaborative supervision data and implementing execution instructions.

In some embodiments, the collaborative supervision perception and control platform 150 may include a plurality of sensors. The plurality of sensors include, but are not limited to, a distributed millimeter-wave radar array, a three-dimensional vision sensor, a torque sensor, and a plurality of other different types of sensors.

In some embodiments, the collaborative supervision perception and control platform may further include a collaborative robot.

The collaborative robot refers to a robot that performs collaborative operations with an operator. In some embodiments, the collaborative robot may include a plurality of components such as a motion control system, a joint motor, mechanical links, an end effector, and a servo driver.

The motion control system refers to a computing unit configured to receive an instruction and generate a control signal. For example, the motion control system includes a controller, or the like.

The servo driver is a power electronic device that drives the joint motor. The joint motor, driven by the servo driver, outputs a required torque and rotational velocity to provide power for the mechanical links.

The mechanical link refers to a rigid component that connects various joints and transmits force and motion.

The end effector refers to a tool or device installed at an end of a mechanical structure of the collaborative robot for directly executing an operation task.

In some embodiments, the motion control system is configured to adjust a physical drive signal applied to the joint motor based on a motion control instruction to drive mechanical links of the collaborative robot to generate a composite motion, so that the end effector completes avoidance. That is, the motion control system drives the joint motor by sending the physical drive signal to the servo driver. The joint motor drives the mechanical links to move, ultimately causing the end effector to complete an avoidance action. In a scenario requiring an emergency stop of the collaborative robot, the motion control system directly sends a hardware instruction to the servo driver to complete emergency braking. More descriptions regarding this part may be found in the related description of FIG. 2.

More descriptions of the above platforms may be found in FIG. 2 to FIG. 4 and related descriptions.

In some embodiments of the present disclosure, the IoT system for sensor-based human-robot collaborative monitoring may form an information operation closed loop among various functional platforms. The IoT system for sensor-based human-robot collaborative monitoring may operate in a coordinated and regular manner. Through real-time perception, dynamic prediction, and intelligent decision-making, the IoT system for sensor-based human-robot collaborative monitoring may achieve safe and efficient human-robot collaborative operations.

FIG. 2 is a flowchart illustrating an exemplary process for sensor-based human-robot collaborative monitoring according to some embodiments of the present disclosure. As shown in FIG. 2, a process 200 includes the following steps. In some embodiments, the process 200 may be performed by the collaborative supervision and management platform 130.

Step 210, obtaining monitoring data of a work area of a collaborative robot.

More descriptions of the collaborative robot may be found in related descriptions of FIG. 1.

The work area refers to a workspace area of the collaborative robot.

The monitoring data refers to data characterizing real-time states of the operator and the collaborative robot at a current moment.

The operator refers to a human worker who performs collaborative operations with the collaborative robot within the work area of the collaborative robot.

In some embodiments, the monitoring data may include first state data of the operator and second state data of the collaborative robot. The first state data refers to state data of the operator at the current moment. The first state data may include a position, a velocity, and an acceleration of the operator at the current moment, or the like. The second state data refers to state data of the collaborative robot at the current moment. The second state data may include joint angles of the collaborative robot, a position, a velocity, and an acceleration of an end effector of the collaborative robot at the current moment, or the like. The position of the operator and the position of the end effector may both be represented by position coordinates in a world coordinate system.

More descriptions of the end effector may be found in related descriptions of FIG. 1.

In some embodiments, the monitoring data may be multi-source data. The collaborative supervision and management platform may obtain the monitoring data of the work area through a plurality of sensors deployed within the work area.

Step 220, determining a collision risk value based on the monitoring data, a first motion trajectory of an operator, and a second motion trajectory of the collaborative robot.

The first motion trajectory refers to a motion trajectory of the operator within a future time period.

The future time period refers to a period of time after the current moment. For example, 2 seconds or 5 seconds in the future. In some embodiments, the future time period may be preset manually.

In some embodiments, the first motion trajectory may be pre-planned by a user. The collaborative supervision and management platform may obtain the first motion trajectory through user input. The user may be the operator or another technical personnel.

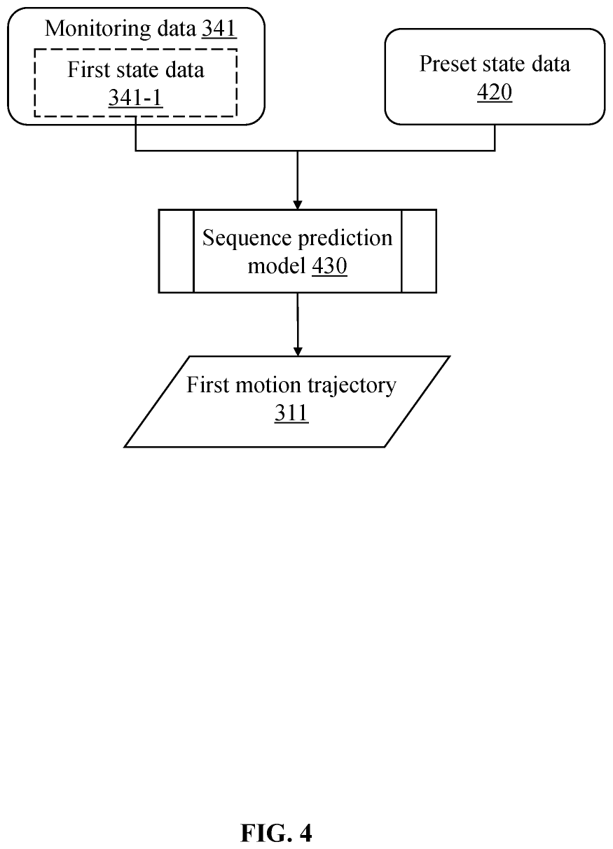

FIG. 4 is an exemplary schematic diagram of a sequence prediction model according to some embodiments of the present disclosure.

In some embodiments, as shown in FIG. 4, the collaborative supervision and management platform is further configured to: determine the first motion trajectory 311 based on the monitoring data 341 and preset state data 420 of the operator through a sequence prediction model 430, wherein the sequence prediction model is a machine learning model.

The sequence prediction model refers to a model for predicting the first motion trajectory.

In some embodiments, the sequence prediction model may be a long short-term memory (LSTM) model, or the like.

The preset state data refers to state data of the operator within the future time period. For example, the preset state data includes positions, velocities, accelerations, etc., of the operator at a plurality of preset future time points within the future time period. In some embodiments, the preset state data may be pre-planned by the user. The collaborative supervision and management platform may obtain the preset state data of the operator through the user input.

In some embodiments, as shown in FIG. 4, an input of the sequence prediction model 430 includes first state data 341-1 in the monitoring data 341 and the preset state data 420 of the operator. An output of the sequence prediction model 430 includes the first motion trajectory 311. That is, the first state data of the operator at the current moment and the preset state data of the future time period are input into the sequence prediction model. The sequence prediction model may output the first motion trajectory of the operator within the future time period.

In some embodiments, the collaborative supervision and management platform may train the sequence prediction model based on a plurality of training samples with training labels.

The training samples and the training labels may be directly obtained based on historical record data. A training sample used in one training may include historical actual state data of a historical operator at a historical first moment and in a historical first time period. A training label corresponding to the training sample is a historical actual motion trajectory of the historical operator in the historical first time period. The historical first moment is before the historical first time period.

In some embodiments, the collaborative supervision and management platform may input the training samples into an initial sequence prediction model, construct a loss function based on the training labels and an output result of the initial sequence prediction model, iteratively update parameters of the initial sequence prediction model based on the loss function, and end iteration when an iteration end condition is satisfied to obtain a trained sequence prediction model. The manner for iterative update includes, but is not limited to, a gradient descent manner. The iteration end condition may be the convergence of the loss function or a count of iterations reaching a threshold.

In some embodiments of the present disclosure, the sequence prediction model is configured to predict a motion trajectory of the operator in the future time period using the first state data of the operator at the current moment and the preset state data of the future time period, enabling perceiving personnel movement in advance, providing relatively sufficient time for collision prediction, reducing unnecessary emergency stops of the collaborative robot, and balancing the safety of human-robot collaboration and operation efficiency.

The second motion trajectory refers to a motion trajectory of the collaborative robot in the future time period. In some embodiments, the collaborative supervision and management platform may directly read a pre-calculated second motion trajectory from a motion control system of the collaborative robot.

The collision risk value refers to a quantitative evaluation index for assessing a probability of physical collision between the collaborative robot and the operator in the future time period. In some embodiments, the collision risk value may be represented by a numerical value from 0 to 1. A larger numerical value indicates a higher probability of physical collision between the collaborative robot and the operator.

In some embodiments, the collaborative supervision and management platform may determine the collision risk value in various ways based on the monitoring data, the first motion trajectory of the operator, and the second motion trajectory of the collaborative robot.

For example, the collaborative supervision and management platform may construct a first target vector based on the monitoring data, the first motion trajectory of the operator, and the second motion trajectory of the collaborative robot. The collaborative supervision and management platform may retrieve, from a first vector database, a historical first vector having the highest vector similarity to the first target vector based on the first target vector, and use a historical collision risk value corresponding to the historical first vector as the collision risk value.

The first vector database includes a plurality of historical first vectors, and each of the plurality of historical first vectors has a corresponding historical collision risk value. The historical first vector is constructed based on historical monitoring data at a historical second moment, a historical actual motion trajectory of the operator in a historical second time period, and a historical actual motion trajectory of the collaborative robot in the historical second time period. The historical second moment is before the historical second time period. The historical second moment and the historical first moment described earlier, and the historical second time period and the historical first time period described earlier may be the same or different, with no correlation.

In some embodiments, for one historical first vector, the collaborative supervision and management platform may count a count M of times the collaborative robot actually performed avoidance and a count N of times the operator and the collaborative robot actually collided in the historical second time period corresponding to the historical first vector, and determine N/M as a historical collision risk value corresponding to the historical first vector. The count M of times the collaborative robot actually performed avoidance refers to a count of times the motion control system of the collaborative robot actually received a motion control instruction to cause the end effector to complete avoidance. The M may be determined based on a count of instruction logs of the collaborative supervision and management platform or a feedback count of the collaborative robot completing avoidance.

In some embodiments, the collaborative supervision and management platform may be further configured to: determine a first collision risk value based on the monitoring data; obtain a first trajectory set and a second trajectory set based on the first motion trajectory and the second motion trajectory; construct a first bounding volume set and a second bounding volume set based on the first trajectory set, the second trajectory set, and a bounding volume radius; determine an intrusion depth set based on the first bounding volume set and the second bounding volume set; determine a second collision risk value based on the intrusion depth set; and determine the collision risk value by performing weighted summation processing based on the first collision risk value and the second collision risk value.

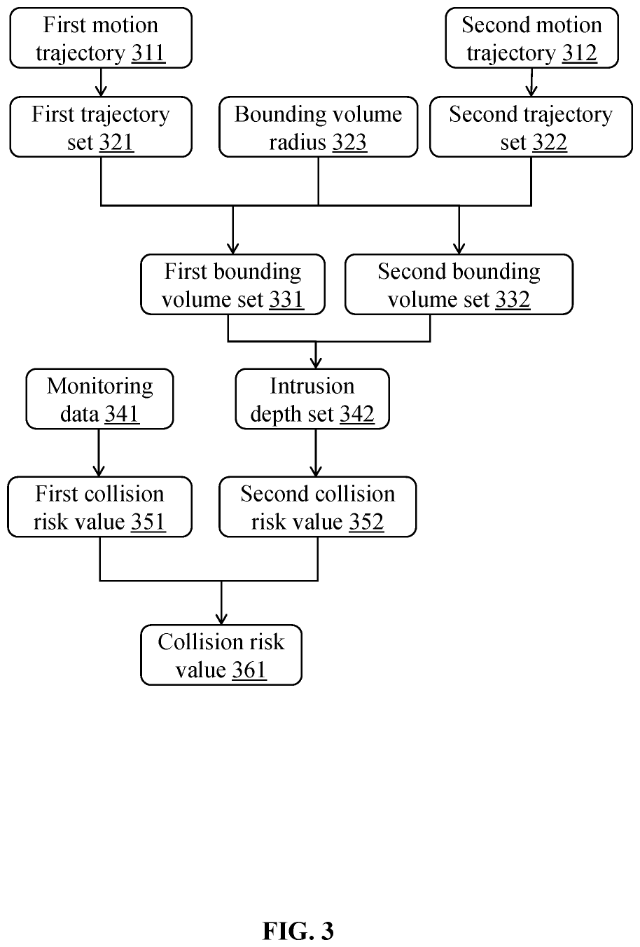

More descriptions about this part may be found in the description related to FIG. 3.

Step 230: determining an avoidance parameter of the collaborative robot based on the monitoring data, the first motion trajectory, the collision risk value, a collision urgency degree, and a movable space range of the collaborative robot.

The collision urgency degree refers to an emergency degree configured to measure an impending collision between the operator and the collaborative robot. In some embodiments, the collision urgency degree may include a minimum predicted distance in the future time period and a shortest contact time in the future time period.

The minimum predicted distance in the future time period refers to a minimum spatial distance between the operator and the collaborative robot within the future time period.

In some embodiments, the collaborative supervision and management platform may determine the minimum predicted distance in the future time period based on the first motion trajectory and the second motion trajectory. For example, the collaborative supervision and management platform may determine the minimum predicted distance in the future time period by calculating a distance between two points that are closest to each other on the first motion trajectory and the second motion trajectory. The minimum predicted distance in the future time period being 0 means that the operator and the collaborative robot will collide within the future time period.

The shortest contact time refers to a shortest time required for the operator and the collaborative robot to collide in a current state.

In some embodiments, the collaborative supervision and management platform may calculate the shortest contact time using a kinematics formula based on a relative position vector and a relative velocity vector of the operator and the collaborative robot at a current moment.

For example, the collaborative supervision and management platform may determine the relative position vector based on a position of the collaborative robot and a position of the operator at the current moment in the monitoring data. The collaborative supervision and management platform may determine the relative velocity vector based on a velocity of the collaborative robot and a velocity of the operator at the current moment in the monitoring data. The collaborative supervision and management platform may project the relative position vector onto a direction of the relative velocity vector, and a length of the projection is recorded as a relative separation distance. The collaborative supervision and management platform may calculate the shortest contact time using the following kinematics formula (1) based on the relative separation distance and a magnitude of the relative velocity vector:

$$TTC = D / V \qquad ( 1 )$$

The TTC denotes the shortest contact time, the D denotes the relative separation distance, and the V denotes the magnitude of the relative velocity vector.

The movable space range refers to a geometric space range in which the collaborative robot may move safely without collision.

In some embodiments, the collaborative supervision and management platform may obtain the movable space range by calculation through a kinematics model of the collaborative robot and a three-dimensional map of the work area. In some embodiments, the collaborative supervision and management platform may obtain the three-dimensional map of the work area through a computer-aided design (CAD) model or prior simultaneous localization and mapping (SLAM), etc. The collaborative supervision and management platform may obtain the kinematics model of the collaborative robot through mathematical calculation software or a robot simulation platform, etc.

The avoidance parameter refers to a motion parameter related to the collaborative robot performing avoidance. In some embodiments, the avoidance parameter may include a movement path, a movement velocity, and a timestamp for the collaborative robot to perform avoidance, etc.

In some embodiments, the collaborative supervision and management platform may determine the avoidance parameter in various ways based on the monitoring data, the first motion trajectory, the collision risk value, the collision urgency degree, and the movable space range of the collaborative robot.

For example, the collaborative supervision and management platform may determine the avoidance parameter by querying a first preset table based on the monitoring data, the first motion trajectory, the collision risk value, the collision urgency degree, and the movable space range of the collaborative robot.

The first preset table includes the monitoring data, the first motion trajectory, the collision risk value, the collision urgency degree, the movable space range of the collaborative robot, and a corresponding avoidance parameter. In some embodiments, the first preset table may be preset manually based on experience.

In some embodiments, the collaborative supervision and management platform may be further configured to: determine an avoidance target based on the task type; and determine the avoidance parameter through a path planning algorithm based on the monitoring data, the first motion trajectory, the collision risk value, the collision urgency degree, the movable space range, and the avoidance target.

The avoidance target refers to a core performance indicator expected to be achieved when performing an avoidance action. In some embodiments, the avoidance target may include a shortest movement path for the collaborative robot to perform avoidance, maintaining an original direction and posture of the end effector while avoiding obstacles, etc.

In some embodiments, the collaborative supervision and management platform may determine the avoidance target by querying a third preset table based on the task type.

The task type refers to a category of a currently executed task. For example, the task type may be a welding task, a handling task, a spraying task, etc. In some embodiments, the collaborative supervision and management platform may determine the task type through the user input.

The third preset table includes a correspondence between the task type and the avoidance target. The third preset table may be preset by an operator based on experience. For example, when the task type is the handling task, a posture of the end effector of the collaborative robot is insensitive, and the avoidance target is a shortest movement path for the collaborative robot to perform avoidance. When the task type is the spraying task, the posture of the end effector of the collaborative robot is highly sensitive, and the avoidance target is to maintain an original direction and the posture of the end effector while avoiding an obstacle.

The path planning algorithm may include, but is not limited to, Rapidly-exploring Random Tree (RRT), Probabilistic Roadmap (PRM), Dynamic Window Approach (DWA), or the like.

In some embodiments, the collaborative supervision and management platform may input the monitoring data, the first motion trajectory, the collision risk value, the collision urgency degree, the movable space range, and the avoidance target into the path planning algorithm for solving. The path planning algorithm automatically outputs avoidance parameters such as the movement path, the movement velocity, and the timestamp.

In some embodiments of the present disclosure, by introducing the avoidance target, avoidance is achieved while considering task efficiency and quality, and the interruption of a task process is reduced.

Step 240, generating a motion control instruction based on the avoidance parameter and sending the motion control instruction to a motion control system of the collaborative robot

The motion control instruction refers to an instruction for controlling the collaborative robot to perform an avoidance motion. In some embodiments, the motion control system is configured to adjust a physical drive signal applied to a joint motor based on the motion control instruction, to drive mechanical links of the collaborative robot to produce a composite motion, enabling an end effector to complete avoidance.

More descriptions regarding the motion control system, the joint motor, the mechanical links, and the end effector may be found in related descriptions of FIG. 1.

In some embodiments, the collaborative supervision and management platform may compile a movement path and a movement velocity in the avoidance parameter according to a controller protocol of the collaborative robot, and automatically generate the motion control instruction. The controller protocol refers to a communication specification defined by a manufacturer of the collaborative robot.

In some embodiments, the motion control system parses the motion control instruction, adjusts the physical drive signal of each joint motor in real time, and drives the mechanical links of the collaborative robot to generate the composite motion, so that the end effector completes avoidance according to the movement path, the movement velocity, and the timestamp of the avoidance parameter.

In some embodiments, the collaborative supervision and management platform may be further configured to determine an avoidance type of the collaborative robot based on the collision risk value, a task type, and a task stage.

The task stage refers to an execution stage in which a current task is located. For example, a human-robot interaction stage, a collaborative robot independent operation stage, an operator independent operation stage, or the like.

The human-robot interaction stage refers to a task stage in which the operator and the collaborative robot cooperate to complete an operation.

In some embodiments, the collaborative supervision and management platform may determine the task type and the task stage through the user input.

More descriptions regarding the task type may be found in related descriptions of FIG. 2 above.

The avoidance type refers to an action type for the collaborative robot to perform avoidance. For example, the avoidance type includes normal execution, emergency stop, retreat, velocity reduction, detour, or the like.

In some embodiments, the collaborative supervision and management platform may determine the avoidance type by querying a second preset table based on the collision risk value, the task type, and the task stage.

The second preset table includes a correspondence relationship among the collision risk value, the task type, the task stage, and the avoidance type. The second preset table may be preset by an operator based on experience. For example, when the task type is a welding task, if the task stage is the human-robot interaction stage and the collision risk value is in a medium risk range (e.g., 0.3 to 0.6), a corresponding avoidance type is velocity reduction. If the task stage is a high-velocity operation stage of the collaborative robot and the collision risk value is in a high risk range (e.g., greater than 0.6), the corresponding avoidance type is retreat.

In some embodiments of the present disclosure, combining the task type and the task stage for collision avoidance decision-making may distinguish between real danger and necessary collaborative interaction, avoiding excessive avoidance or insufficient response, and achieving an optimal balance between safety and efficiency.

In some embodiments, the collaborative supervision and management platform may be further configured to: in response to determining that the avoidance type is an emergency stop, send a hardware instruction to a servo driver of the collaborative robot to control the collaborative robot to perform the emergency stop.

More descriptions regarding the servo driver may be found in related descriptions of FIG. 1.

The hardware instruction refers to a fast braking instruction directly acting on the servo driver. For example, the hardware instruction includes an instruction for controlling safe torque off. In some embodiments, the hardware instruction may be preset by an operator.

In some embodiments, when the avoidance type is determined to be the emergency stop, the collaborative supervision and management platform immediately sends the hardware instruction to the servo driver. The servo driver may immediately turn off safe torque, so that the collaborative robot achieves the emergency stop.

In some embodiments of the present disclosure, through a hardware-level emergency stop instruction, the fastest and most reliable braking may be achieved in extremely dangerous situations, personnel safety is ensured, reliance on upper-layer software is reduced, and response certainty is improved.

In some embodiments of the present disclosure, a complete, closed-loop human-robot collaborative safety monitoring process is constructed. Prospective risk assessment is achieved through multi-source perception and trajectory prediction. Collisions are effectively prevented, and interruptions to an operation process are minimized. The safety of human-robot collaboration and overall operation efficiency are significantly improved.

FIG. 3 is an exemplary schematic diagram of determining a collision risk value according to some embodiments of the present disclosure.

In some embodiments, as shown in FIG. 3, the collaborative supervision and management platform may be further configured to: determine a first collision risk value 351 based on monitoring data 341; obtain a first trajectory set 321 and a second trajectory set 322 based on a first motion trajectory 311 and a second motion trajectory 312; construct a first bounding volume set 331 and a second bounding volume set 332 based on the first trajectory set 321, the second trajectory set 322, and a bounding volume radius 323; determine an intrusion depth set 342 based on the first bounding volume set 332 and the second bounding volume set 332; determine a second collision risk value 352 based on the intrusion depth set 342; and determine the collision risk value 362 by performing weighted summation processing based on the first collision risk value 351 and the second collision risk value 352.

More descriptions regarding the monitoring data, the first motion trajectory, the second motion trajectory, and the collision risk value may be found in FIG. 2 and related descriptions thereof.

The first collision risk value refers to a component of the collision risk value for a physical collision between the collaborative robot and the operator, determined based on historical experience.

In some embodiments, the collaborative supervision and management platform may determine the first collision risk value by querying a second vector database based on the monitoring data.

For example, the collaborative supervision and management platform may construct a second target vector based on first state data of the operator and second state data of the collaborative robot at the current moment in the monitoring data. The collaborative supervision and management platform may retrieve a historical second vector having a highest vector similarity to the second target vector in the second vector database based on the second target vector, and use a historical first collision risk value corresponding to the historical second vector as the first collision risk value.

The second vector database includes a plurality of historical second vectors, and each historical second vector has a corresponding historical first collision risk value. A historical second vector is constructed based on historical actual state data of the operator and historical actual state data of the collaborative robot in historical monitoring data at a historical third moment.

The historical first collision risk value corresponding to the historical second vector may be determined based on historical actual collision situations in a historical third period. For example, for the historical second vector corresponding to the historical third moment, the collaborative supervision and management platform may determine N2/M2 as the historical first collision risk value corresponding to the historical second vector by counting a count M2 of times the collaborative robot actually performed avoidance and a count N2 of times the operator and the collaborative robot actually collided in the historical third period. The historical third period is a subsequent period of the historical third moment. The historical third moment and the historical first moment and historical second moment described earlier, as well as the historical third period and the historical first period and historical second period described earlier, may be the same or different, with no correlation relationship.

The first trajectory set refers to a set of a plurality of discrete points on the first motion trajectory of the operator.

In some embodiments, the collaborative supervision and management platform may extract N time points within a future period corresponding to the first motion trajectory. The collaborative supervision and management platform may determine N positions corresponding to the N time points in the first motion trajectory (recorded as N first trajectory points), and determine a set of the N first trajectory points as the first trajectory set. N may be set by an operator based on historical experience, and an interval between adjacent time points may be equal or approximately equal.

The second trajectory set refers to a set of a plurality of discrete points on the second motion trajectory of the collaborative robot. An acquisition manner for the second trajectory set may be found in the acquisition manner for the first trajectory set. Positions corresponding to N time points in the second motion trajectory are recorded as N second trajectory points. That is, the second trajectory set is a set formed by the N second trajectory points. The N time points taken from the first trajectory set and the N time points taken from the second trajectory set are the same corresponding N time points.

The bounding volume radius refers to a radius of a bounding volume.

The bounding volume refers to a three-dimensional geometric body constructed to simplify collision detection and characterize a safe operation range of the operator or the collaborative robot. A shape of the bounding volume may be a sphere, a cylinder, or the like.

For ease of description, the present disclosure takes a spherical bounding volume as an example. The bounding volume may be constructed with the position of the operator or the position of the collaborative robot as a sphere center and with the bounding volume radius as a radius.

In some embodiments, the bounding volume radius includes a first bounding volume radius and a second bounding volume radius. The first bounding volume radius refers to a radius of a bounding volume centered on the operator. The second bounding volume radius refers to a radius of a bounding volume centered on the collaborative robot.

In some embodiments, the bounding volume radius may be determined based on a volume size of the operator or the collaborative robot. For example, a larger volume of the operator corresponds to a larger first bounding volume radius. A larger volume of the collaborative robot corresponds to a larger second bounding volume radius.

In some embodiments, the bounding volume radius is related to at least one of a current velocity or a current acceleration of an enclosed object.

The enclosed object refers to an object enclosed by the bounding volume, including the operator or a body of the collaborative robot.

In some embodiments, a larger current velocity and/or a larger current acceleration of the enclosed object corresponds to a larger bounding volume radius.

In some embodiments of the present disclosure, a safety boundary is dynamically adjusted based on an object's velocity and an object's acceleration, thereby optimizing a collaborative space while ensuring safety.

In some embodiments, the collaborative supervision and management platform may be further configured to: in response to determining that the task stage is a human-robot interaction stage, adjust the bounding volume radius based on a reduction coefficient.

More descriptions regarding the human-robot interaction stage may be found in the related description of FIG. 2.

The reduction coefficient refers to a scaling factor configured to reduce the bounding volume radius. In some embodiments, the reduction coefficient is less than 1. Specifically, the reduction coefficient may be set manually based on historical experience.

In some embodiments, when the task stage is the human-robot interaction stage, the bounding volume radius needs to be multiplied by the reduction coefficient for reduction adjustment.

In some embodiments of the present disclosure, by introducing the reduction coefficient, a safety boundary is reduced while ensuring safety, allowing closer collaborative operation between a human and a robot, and avoiding excessive avoidance.

The first bounding volume set refers to a set of first bounding volumes.

The first bounding volume refers to a bounding volume constructed with a first trajectory point in the first trajectory set of the operator as a sphere center and with the first bounding volume radius as a radius. One first trajectory point corresponds to constructing one first bounding volume. N first bounding volumes constructed corresponding to N first trajectory points in the first trajectory set form the first bounding volume set.

The second bounding volume set refers to a set of second bounding volumes.

The second bounding volume refers to a bounding volume constructed with a second trajectory point in the second trajectory set of the collaborative robot as a sphere center and with the second bounding volume radius as a radius. One second trajectory point corresponds to constructing one second bounding volume. N second bounding volumes constructed corresponding to N second trajectory points in the second trajectory set form the second bounding volume set.

The intrusion depth set refers to a set of intrusion depths.

The intrusion depth refers to an overlapping length of radii of the first bounding volume and the second bounding volume corresponding to a same time point. The overlapping length of radii may refer to a length of a line connecting sphere centers of the first bounding volume and the second bounding volume within a common overlapping region of the two spheres. One time point corresponds to one first bounding volume and one second bounding volume, i.e., one time point corresponds to one intrusion depth. A set formed by N intrusion depths corresponding to N time points is the intrusion depth set.

In some embodiments, the collaborative supervision and management platform may calculate and determine the intrusion depth set using the following formula (2).

$$P ( {t}_{i} ) = max ( 0 , {R}_{human} ( {t}_{i} ) + {R}_{robot} ( {t}_{i} ) - D ( {t}_{i} ) ) , i ∈ \{ 1 , … , N \} , i ∈ Z \qquad ( 2 )$$

The P(tᵢ) denotes an intrusion depth at a time point tᵢ; the Rₕᵤₘₐₙ(tᵢ) denotes a first bounding volume radius of a first bounding volume of the operator at the time point tᵢ; the R_{robot}(tᵢ) denotes a second bounding volume radius of a second bounding volume of the collaborative robot at the time point tᵢ; the D(tᵢ) denotes a Euclidean distance between a sphere center of the first bounding volume and a sphere center of the second bounding volume.

The second collision risk value refers to a risk value component in the collision risk value that characterizes a risk determined based on spatiotemporal overlap analysis.

In some embodiments, the collaborative supervision and management platform may traverse the intrusion depth set formed by N intrusion depths corresponding to time points from t₁ to t_{N}, map a maximum intrusion depth in the intrusion depth set to [0, 1] through a nonlinear function (e.g., a Sigmoid function), and determine a mapping result as the second collision risk value. The nonlinear function may be preset manually based on historical experience.

In some embodiments, the collaborative supervision and management platform may perform weighted summation processing on the first collision risk value and the second collision risk value, and determine a result value as the collision risk value.

In some embodiments, a weight corresponding to the first collision risk value and a weight corresponding to the second collision risk value may be preset manually.

In some embodiments, the weight corresponding to the first collision risk value and the weight corresponding to the second collision risk value may be related to a confidence level of the first motion trajectory.

The confidence level of the first motion trajectory refers to an evaluation value of reliability of a predicted future motion trajectory of the operator.

In some embodiments, an output of a sequence prediction model may further include the confidence level of the first motion trajectory. More descriptions regarding the sequence prediction model may be found in the related description of FIG. 4. Correspondingly, a training label of the sequence prediction model may further include a confidence level of a first motion trajectory of a historical operator in a historical first time period (i.e., a historical estimated motion trajectory of the historical operator in the historical first time period). The confidence level may be labeled manually based on an overlap degree between the first motion trajectory of the historical operator in the historical first time period and a historical actual motion trajectory of the historical operator in the historical first time period. A higher overlap degree corresponds to a greater confidence level of the first motion trajectory of the historical operator in the historical first time period.

In some embodiments, when the confidence level of the first motion trajectory is greater than a confidence level threshold, the weight corresponding to the second collision risk value is greater than the weight corresponding to the first collision risk value. When the confidence level of the first motion trajectory is less than or equal to the confidence level threshold, the weight corresponding to the second collision risk value is less than or equal to the weight corresponding to the first collision risk value. The confidence level threshold may be preset manually based on historical experience.

In some embodiments of the present disclosure, by dynamically adjusting weights of an empirical value and a predicted value based on the confidence level of the first motion trajectory, a predicted result is emphasized when the confidence level is high, and real-time data is emphasized when the confidence level is low, thereby improving the accuracy of risk assessment.

In some embodiments of the present disclosure, by the complementing of the first collision risk value and the second collision risk value, combining empirical risk and prospective analysis, the comprehensiveness and reliability of collision risk assessment are improved, and limitations of a single manner are avoided.

Embodiments in the present disclosure are merely for illustration and description, and do not limit the scope of the present disclosure. For those skilled in the art, various modifications and changes that may be made under the guidance of the present disclosure still fall within the scope of the present disclosure.

Furthermore, certain features, structures, or characteristics in one or more embodiments of the present disclosure may be appropriately combined.

In some embodiments, numbers describing components and attribute quantities are used. It should be understood that such numbers used to describe embodiments, in some examples, are modified by modifiers such as “about,” “approximately,” or “substantially.” Unless otherwise stated, the terms “about,” “approximately,” or “substantially” indicate that the stated number allows a variation of ±20%. Accordingly, in some embodiments, numerical parameters used in the specification and claims are approximations, which may vary depending on the desired characteristics of individual embodiments. In some embodiments, numerical parameters should consider the prescribed number of significant digits and apply general digit retention methods. Although numerical ranges and parameters used to confirm the breadth of the scope in some embodiments of the present disclosure are approximations, in specific embodiments, such numerical values are set as precisely as possible within a feasible range.

If descriptions, definitions, and/or usage of terms in the attached materials of the present disclosure are inconsistent with or conflict with the descriptions, definitions, and/or usage of terms in the present disclosure, the descriptions, definitions, and/or usage of terms in the present disclosure prevail.

What is claimed is:

1. An Internet of Things (IoT) system for sensor-based human-robot collaborative monitoring, comprising a collaborative supervision and management platform;
the collaborative supervision and management platform is configured to:
obtain monitoring data of a work area of a collaborative robot;
determine a collision risk value based on the monitoring data, a first motion trajectory of an operator, and a second motion trajectory of the collaborative robot;
determine an avoidance parameter of the collaborative robot based on the monitoring data, the first motion trajectory, the collision risk value, a collision urgency degree, and a movable space range of the collaborative robot; and
generate a motion control instruction based on the avoidance parameter and send the motion control instruction to a motion control system of the collaborative robot;
wherein the motion control system is configured to adjust a physical drive signal applied to a joint motor based on the motion control instruction, to drive mechanical links of the collaborative robot to produce a composite motion, enabling an end effector to complete avoidance.

2. The IoT system according to claim 1, wherein the collaborative supervision and management platform is further configured to:
determine an avoidance type of the collaborative robot based on the collision risk value, a task type, and a task stage.

3. The IoT system according to claim 2, wherein the collaborative supervision and management platform is further configured to:
in response to determining that the avoidance type is an emergency stop, send a hardware instruction to a servo driver of the collaborative robot to control the collaborative robot to perform the emergency stop.

4. The IoT system according to claim 1, wherein the collaborative supervision and management platform is further configured to:
determine a first collision risk value based on the monitoring data;
obtain a first trajectory set and a second trajectory set based on the first motion trajectory and the second motion trajectory;
construct a first bounding volume set and a second bounding volume set based on the first trajectory set, the second trajectory set, and a bounding volume radius;
determine an intrusion depth set based on the first bounding volume set and the second bounding volume set;
determine a second collision risk value based on the intrusion depth set; and
determine the collision risk value by performing weighted summation processing based on the first collision risk value and the second collision risk value.

5. The IoT system according to claim 4, wherein the bounding volume radius is related to at least one of a current velocity or a current acceleration of an enclosed object.

6. The IoT system according to claim 5, wherein the collaborative supervision and management platform is further configured to:
in response to determining that the task stage is a human-robot interaction stage, adjust the bounding volume radius based on a reduction coefficient.

7. The IoT system according to claim 4, wherein a weight corresponding to the first collision risk value and a weight corresponding to the second collision risk value are related to a confidence level of the first motion trajectory.

8. The IoT system according to claim 1, wherein the collaborative supervision and management platform is further configured to:
determine the first motion trajectory based on the monitoring data and preset state data of the operator through a sequence prediction model, wherein the sequence prediction model is a machine learning model.

9. The IoT system according to claim 1, wherein the collaborative supervision and management platform is further configured to:
determine an avoidance target based on the task type; and
determine the avoidance parameter through a path planning algorithm based on the monitoring data, the first motion trajectory, the collision risk value, the collision urgency degree, the movable space range, and the avoidance target.

10. A method for sensor-based human-robot collaborative monitoring, wherein the method is executed by a collaborative supervision and management platform in an Internet of Things (IoT) system for sensor-based human-robot collaborative monitoring, and the method comprises:
obtaining monitoring data of a work area of a collaborative robot;
determining a collision risk value based on the monitoring data, a first motion trajectory of an operator, and a second motion trajectory of the collaborative robot;
determining an avoidance parameter of the collaborative robot based on the monitoring data, the first motion trajectory, the collision risk value, a collision urgency degree, and a movable space range of the collaborative robot; and
generating a motion control instruction based on the avoidance parameter and sending the motion control instruction to a motion control system of the collaborative robot;
wherein the motion control system is configured to adjust a physical drive signal applied to a joint motor based on the motion control instruction, to drive mechanical links of the collaborative robot to produce a composite motion, enabling an end effector to complete avoidance.

11. The method according to claim 10, wherein the method further comprises:
determining an avoidance type of the collaborative robot based on the collision risk value, a task type, and a task stage.

12. The method according to claim 11, wherein the method further comprises:
in response to determining that the avoidance type is an emergency stop, sending a hardware instruction to a servo driver of the collaborative robot to control the collaborative robot to perform the emergency stop.

13. The method according to claim 10, wherein the determining a collision risk value based on the monitoring data, a first motion trajectory of an operator, and a second motion trajectory of the collaborative robot further includes:
determining a first collision risk value based on the monitoring data;
obtaining a first trajectory set and a second trajectory set based on the first motion trajectory and the second motion trajectory;
constructing a first bounding volume set and a second bounding volume set based on the first trajectory set, the second trajectory set, and a bounding volume radius;
determining an intrusion depth set based on the first bounding volume set and the second bounding volume set;
determining a second collision risk value based on the intrusion depth set; and
determining the collision risk value by performing weighted summation processing based on the first collision risk value and the second collision risk value.

14. The method according to claim 13, wherein the bounding volume radius is related to at least one of a current velocity or a current acceleration of an enclosed object.

15. The method according to claim 14, wherein the method further comprises:
in response to determining that the task stage is a human-robot interaction stage, adjusting the bounding volume radius based on a reduction coefficient.

16. The method according to claim 13, wherein a weight corresponding to the first collision risk value and a weight corresponding to the second collision risk value are related to a confidence level of the first motion trajectory.

17. The method according to claim 10, wherein the method further comprises:
determining the first motion trajectory based on the monitoring data and preset state data of the operator through a sequence prediction model, wherein the sequence prediction model is a machine learning model.

18. The method according to claim 10, wherein the determining an avoidance parameter of the collaborative robot based on the monitoring data, the first motion trajectory, the collision risk value, a collision urgency degree, and a movable space range of the collaborative robot includes:
determining an avoidance target based on the task type; and
determining the avoidance parameter through a path planning algorithm based on the monitoring data, the first motion trajectory, the collision risk value, the collision urgency degree, the movable space range, and the avoidance target.

19. A non-transitory computer-readable storage medium, storing computer instructions, wherein when a computer reads the computer instructions in the storage medium, the computer executes the method according to claim 10.
